(19) United States
(12) Patent Application Publication
(10) Pub. No.: US 2003/0162007 A1
(43) Pub. Date: Aug. 28, 2003

(54) Energy converting article and method of making

(76) Inventors: James W. Klett, Knoxville, TN (US); Robert J. Lauf, Oak Ridge, TN (US); Michael A. Acree, Valley Village, CA (US)

Correspondence Address: UT-Battelle, LLC, 111 Union Valley Rd., PO Box 2008, Mail Stop 6498, Oak Ridge, TN, 37831, US

(21) Appl. No.: 10/082,614

(22) Filed: Feb. 25, 2002

(51) Int. Cl. B32B 3/26

(52) U.S. Cl. 428/304.4; 428/311.51

(57) ABSTRACT

A graded composite energy converting article having a working surface of carbon-bonded carbon-fiber (CBCF) material that can absorb light, RF, microwaves, or other forms of energy and convert this energy to sensible heat. Conversely, CBCF can take sensible heat and convert it to radiative emissions of IR energy. Energy is conducted through the article by carbon foam to a secondary surface. The graded composite is made by first heating pitch under pressure to create the foam, which is then pyrolyzed and graphitized to create graphitic, open-cell foam. A slurry of chopped carbon fibers and organic binder in water or solvent is prepared and deposited on a working surface of the foam, preferably infiltrating the foam to some depth. The green body is dried, cured, and carbonized, creating a graded body of carbon foam in conductive thermal contact with a working surface of CBCF. Secondary surfaces of the foam may optionally be metal-infiltrated for added strength, brazability, or other purposes. The article may be used for optical absorbers, baffles, beam stops, RF and microwave loads, radiators, electron collectors, and other uses where energy is passively converted from one form to another and superior thermal transport is required.

The United States Government has rights in this invention pursuant to contract no. DE-AC05-00OR22725 between the United States Department of Energy and UT-Battelle, LLC.

### TECHNICAL FIELD

The present invention relates to passive materials and components capable of absorbing, converting, or radiating energy at a surface, and more particularly to the use of functionally-graded composites of carbon foam and carbon fibers in order to more effectively conduct heat to and from the working surface to a secondary surface and more effectively convert one form of energy into another at the working surface.

### BACKGROUND OF THE INVENTION

In many engineering fields there is a need for passive surfaces and components that can absorb energy, radiate energy, or convert one form of energy to another. Some examples are the following: Passive radiators are crucial components in many space-borne power systems in which waste heat must be radiated into space. Microwave or RF loads are used in many systems, especially at high power, for example to protect microwave generators from reflected power, suppress oscillations, and so on. Optical absorbers eliminate stray light in telescopes and sensors, and are also used as beam stops for lasers. Further, in certain microwave tubes low-Z coatings are applied in the collector to suppress the emission of secondary electrons caused by the impingement of the spent electron beam.

Prior work has demonstrated that low-density carbon-bonded carbon-fiber (CBCF) composites can perform a number of useful roles in the absorption, conversion, and radiation of energy. U.S. Pat. No. 5,243,464 describes the use of CBCF as a black surface to absorb or scatter unwanted light, for example as an optical baffle in a telescope or as a beam stop for a laser. A related U.S. Pat. No. 5,313,325, describes the use of CBCF as a blackbody emitter. U.S. Pat. No. 5,742,211 claims an RF absorbing device using CBCF as the lossy element, and also describes the use of a tapered body of CBCF to perform the added function of impedance grading or impedance matching to further optimize the absorption of unwanted RF signals. U.S. Pat. No. 5,786,666 describes the use of CBCF to absorb an impinging electron beam while minimizing the yield of secondary electrons, particularly for the collector in a microwave amplifier tube.

It will be appreciated that in all of these applications, the flow of heat is a crucial part of the engineering requirements. For absorbent components, the impinging light, RF, or electron beam energy is converted to heat, which must somehow be conducted away from the working surface. Conversely, for radiative components, heat must be efficiently conducted to the working surface where an emissive coating then converts it to light (visible and/or IR). Several means have been suggested to provide good thermal coupling of CBCF to a substrate or other structure, all of which are fundamentally limited to some degree by the inherently poor thermal conductivity of the CBCF itself. U.S. Pat. No. 5,648,180 describes a method in which one surface of the CBCF is infiltrated with pitch or a similar precursor material, which is then carbonized to form a relatively impermeable carbon layer. This layer may then be brazed to a metallic structure, with the impermeable layer helping prevent the braze alloy from “wicking” into the CBCF. Alternatively, U.S. Pat. 5,243,464 describes the use of a carbonizable adhesive to affix the CBCF to a dense graphite substrate. The adhesive is then carbonized in order to create a completely carbonaceous assembly. However, none of the aforementioned approaches creates an optimal thermal path between the working surface and the underlying structure, while preserving the desirable attributes of the CBCF.

It is therefore an object of this invention to create a composite article in which a working surface converts one form of energy to another, while an underlying thermally conductive material transports heat into or out of this working surface layer to or from a secondary surface.

It is another object of this invention to create a composite article in which a working surface absorbs radiant energy and converts it to sensible heat, and an underlying material conducts this heat away from the working surface.

It is another object of this invention to create a composite article in which an underlying material conducts sensible heat to a working surface material, which converts sensible heat to radiant energy for radiative transfer to a surrounding medium.

It is another object of this invention to create a composite article in which carbon fibers are in direct thermal connection with a highly conductive carbon foam, whereby the transfer of energy into or out of the carbon fibers is enhanced.

It is another object of this invention to provide a means of making a graded composite article useful for the conversion of energy from one form to another.

It is another object of this invention to provide a means of making a composite article comprising CBCF and carbon foam, whereby the CBCF absorbs light, electromagnetic energy, or a beam of energetic particles and converts this energy to sensible heat while the carbon foam conducts this sensible heat away from the CBCF.

It is another object of this invention to provide a means of making a composite article comprising CBCF and carbon foam, whereby the carbon foam conducts sensible heat toward the CBCF and the CBCF converts this sensible heat to radiant energy for transfer to a surrounding medium.

Other objects and advantages will be accomplished by the present invention, which is designed to create a graded structure of carbon foam and CBCF in intimate thermal and mechanical contact for the efficient absorption or radiation of thermal energy and the efficient conversion and transport of this energy for various engineering purposes. Some applicable purposes include optical baffles and beam stops, thermal radiators, signature control, microwave and RF absorption, and secondary electron suppression.

Further and other objects and advantages of the present invention will become apparent from the description contained herein, read together with the attached drawings in which:

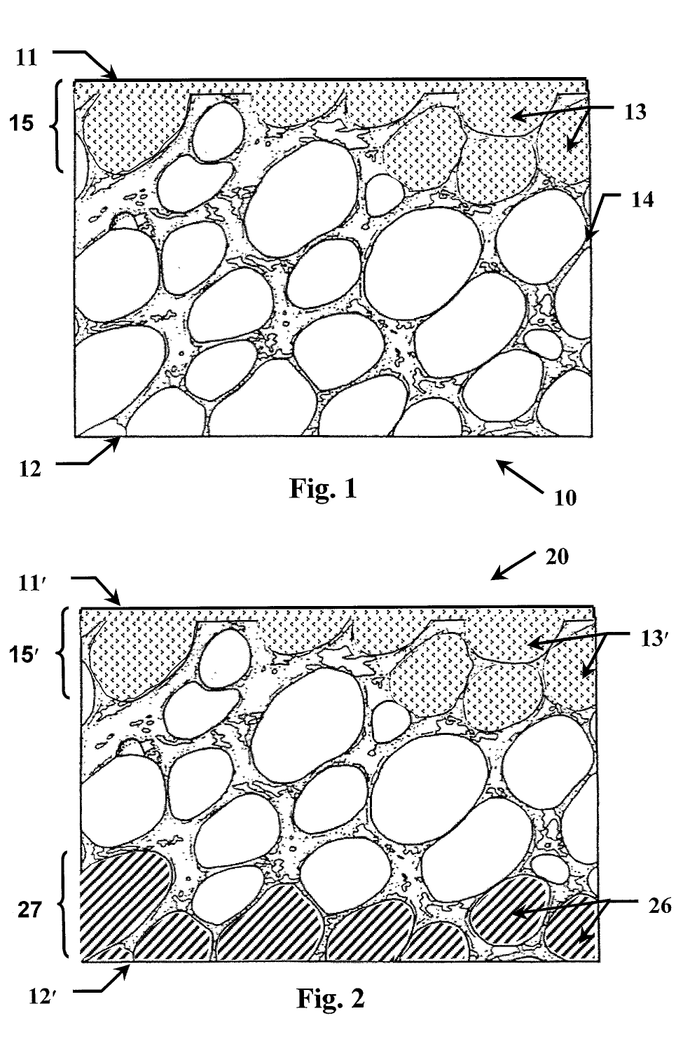

FIG. 1 illustrates a cross section of the inventive material in which a graded layer of CBCF is disposed on one surface of an open-cell carbon foam;

FIG. 2 illustrates another embodiment of the inventive material in which a graded layer of CBCF is disposed on one surface of an open-cell carbon foam and another surface of the foam is infiltrated with a metal alloy;

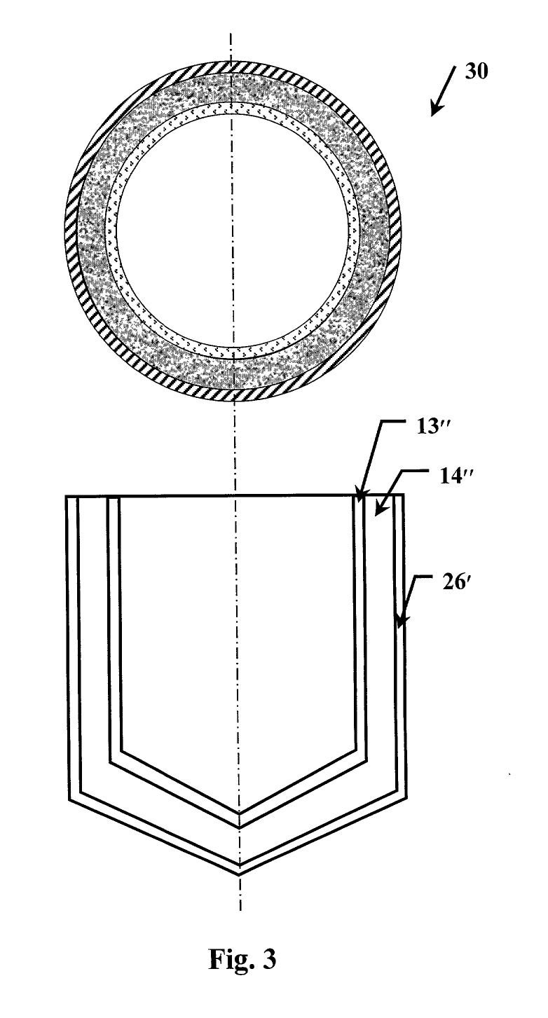

FIG. 3 illustrates another embodiment of the inventive material in which a graded layer of CBCF is disposed on the inner surface of a generally cylindrical body of open-cell carbon foam and the outer surface of the foam is infiltrated with a metal alloy to facilitate brazing the body into the collector of a microwave tube.

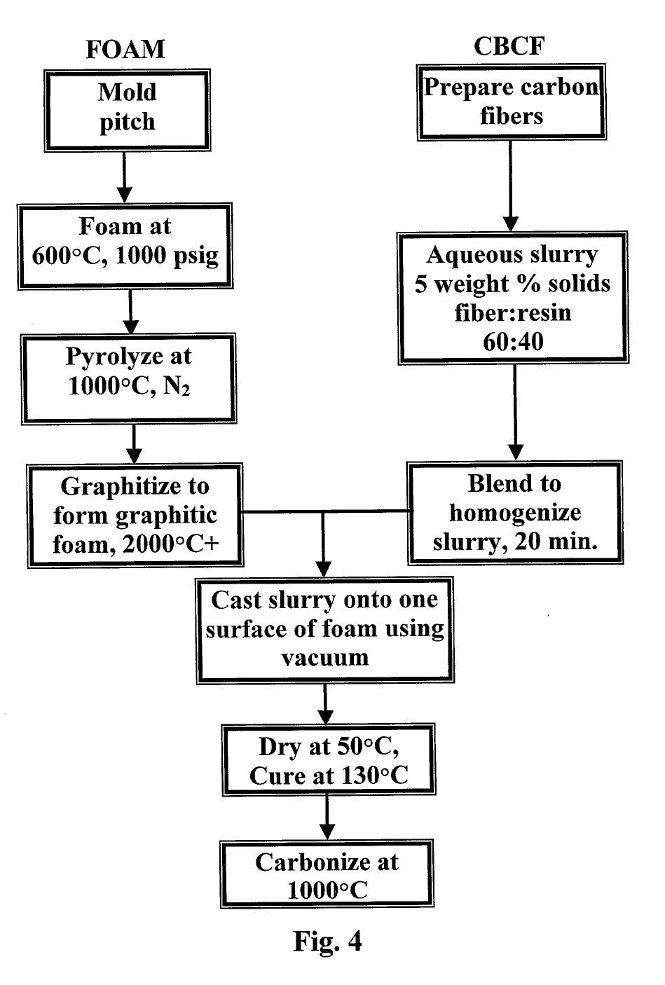

FIG. 4 is a flow diagram of one preferred process for making the inventive material.

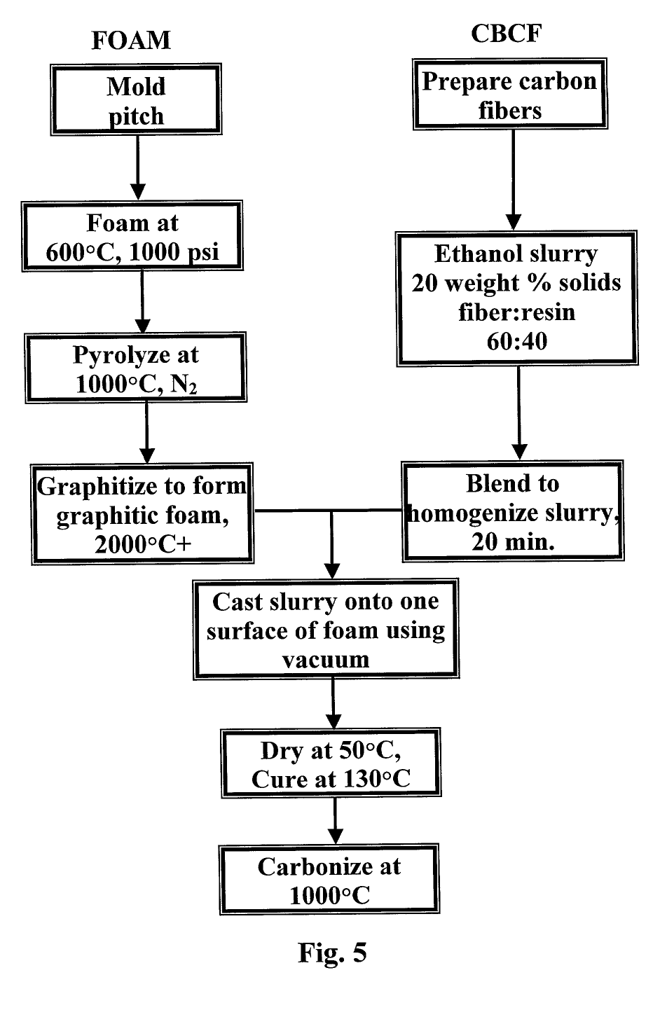

FIG. 5 is a flow diagram of another preferred embodiment of the inventive process.

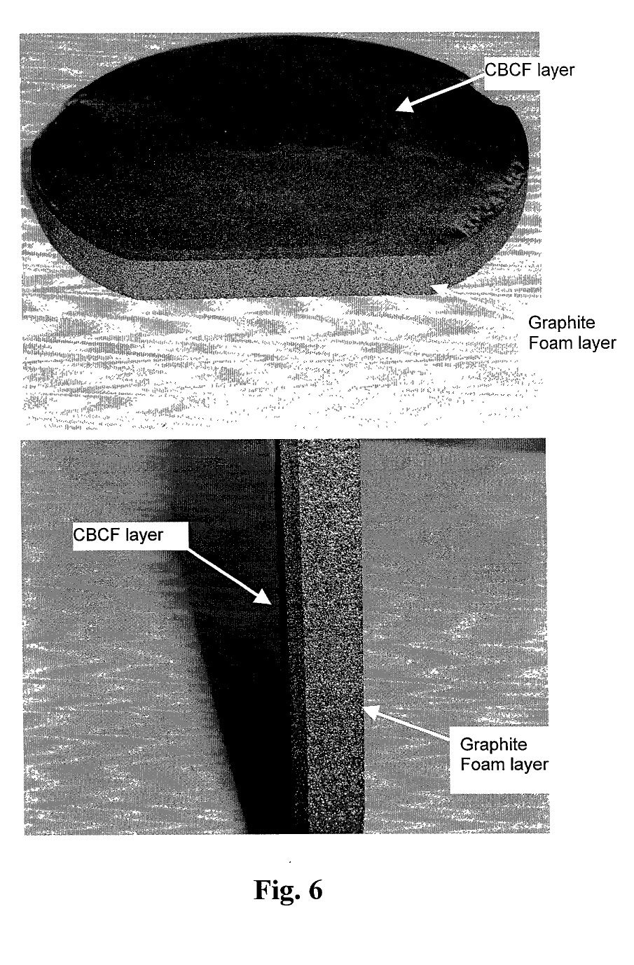

FIG. 6 is a photograph of the article made in example 4.

FIG. 7 is a photograph of the article made in example 5 after carbonization at 1100° C.

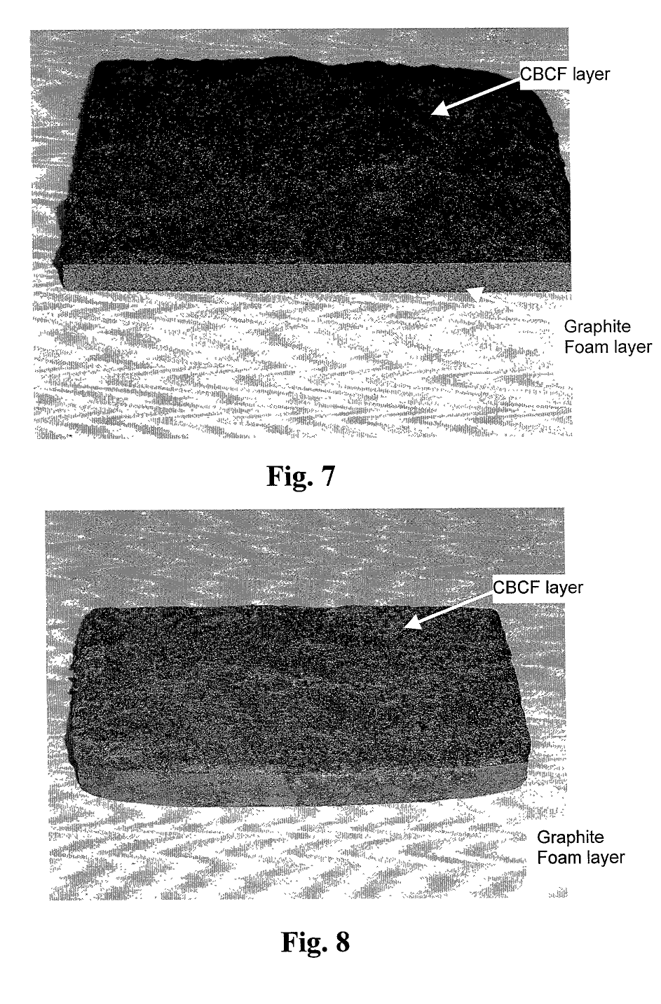

FIG. 8 is a photograph of the article made in example 5 after carbonization at 2800° C.

### DETAILED DESCRIPTION OF THE INVENTION

In its most general terms, the invention comprises a graded composite having at least the following two components; a first energy-converting material on a working surface comprising a surface layer of CBCF and a second energy-conducting material comprising carbon foam having a secondary surface. The CBCF can absorb light, RF, microwaves, or other forms of energy and convert this energy to sensible heat. Conversely, CBCF can take sensible heat and convert it to radiative emissions of IR energy. While both of these individual materials are known in the art, and they present a desirable combination of physical properties, they are made by substantially different processes.

Generally, CBCF material is prepared by mixing chopped carbon fibers and a carbonizable binder phase such as phenolic resin or the like in an aqueous slurry. The slurry is vacuum molded and dried, then heated slowly to cure the resin, crosslinking the resin and bonding the fibers together into a low-density composite body. The composite is then heated in a nonreactive atmosphere such as nitrogen, noble gas or vacuum, to a temperature of at least about 1200° C., preferably about 1600° C., to carbonize the resin phase. The finished carbon bonded carbon fiber (CBCF) product is believed to achieve its high optical absorption or emission by virtue of numerous microscopic spaces between its constituent fibers and because both the fibers and binder phase are black.

The production of low density chopped-fiber CBCF composites has previously been devoted to the manufacture of high-temperature thermal insulation for specialized furnaces and particularly for radioisotope thermal generators. For more information, see the following report published by Oak Ridge National Laboratory, Oak Ridge, Tenn.: G. C. Wei and J. M. Robbins, Development and Characterization of Carbon-Bonded Carbon-Fiber Insulation for Radioisotope Space Power Systems, Report No. ORNL/TM-9381, 1985, the entirety of which is incorporated herein by reference. The previously unnoticed, unexpected, and unappreciated ability to convert one form of energy to another is the subject of the aforementioned U.S. Pat. Nos. 5,243,464; 5,313,325; 5,742,211; and 5,786,666. The carbon fibers used in the preparation of the energy-converting material are preferably of small diameter, generally not more than about 20 μm, and of short length, generally not more than about 1 mm, more preferably not more than about 0.5 mm. Larger sized fibers can be pretreated to reduce the size in order to produce optimally effective light emitting or absorbing components. Rayon fibers, (C₆O₅H₁₀)ₙ, chopped to lengths of less than about 1 mm, are especially suitable. Carbon fibers derived from polyacrylonitrile (PAN), (CH₂CHCN)ₙ, are also suitable. Carbon fibers derived from mesophase pitch are also suitable and preferable when high conductivity is needed or desired. Light absorbing or emitting articles prepared with PAN will have additional beneficial properties such as increased resistance to thermal damage. Suitable carbon fibers can also be derived from coal or petroleum pitch.

The preferred binder phase is a carbonizable organic material such as phenolic resin. The resin is preferably pretreated by sieving prior to use, in order to produce optimally effective CBCF components. A suitable binder phase is a powdered phenolic resin available under the trade name “Durez 22352” from Occidental Chemical Corp., Durez Div., North Tonawanda, N.Y., U.S.A. This particular phenolic resin is a B-stage, two-step, thermosetting resin comprising novolac, (C₆O₅OHCH₂)ₙ, containing about 8 wt % of hexamethylenetetramine, (CH₂)₆N₄, an activator for polymerization.

The energy-conducting medium is carbon foam, which is preferably made by pouring petroleum pitch into a suitable mold, heating in a pressure furnace to 600° C. under an overpressure of 1000 psig nitrogen gas, during which time the pitch foams and partially polymerizes, thereby forming a somewhat rigid organic foam. This foam is then pyrolyzed to about 1000° C. in nitrogen, during which time carbonization takes place. The carbonized foam is then graphitized at temperatures above 2500° C. in an inert atmosphere (typically argon) as described generally in U.S. Pat. No. 6,033,506.

Several methods were attempted to combine CBCF and carbon foam, as described in the following examples.

### EXAMPLE 1

Chopped PAN-derived carbon fibers (Fortafil 3(c) milled 100 micron fibers) were added directly to petroleum pitch. The pitch was then foamed, carbonized, and graphitized as described above. The final material had incorporated the fibers into the cell walls of the foam, but the fibers were lying essentially parallel to the cell surface. In this form the fibers were not useful for any of the intended energy conversions. They did not contribute to optical emission or absorption because they did not protrude from the surface or create tiny openings needed for blackbody behavior. Likewise, they would not provide the desired suppression of secondary electrons for the same reason. Lastly, they would not absorb microwave or RF power, because they were completely buried within the highly conductive (graphitic) cell walls of the foam.

### EXAMPLE 2

A sample of low-density CBCF was made following standard procedures as described in detail above. Petroleum pitch was applied to one surface of the CBCF billet and allowed to partially infiltrate the porous composite. The pitch was then foamed, carbonized, and graphitized as described above. Upon examination of the finished composite, it was discovered that the carbon foam had undergone significant shrinkage during the carbonization and graphitization processes. Because the CBCF was dimensionally stable, the resulting differential shrinkage caused the foam layer to catastrophically crack, rendering the assembly useless.

In view of the foregoing results, various experiments were conducted to develop a suitable processing scheme in which the carbon foam was created first and then a graded concentration of CBCF was built up through several different deposition/infiltration techniques.

### EXAMPLE 3

A sample of Durez 22352 phenolic resin was analyzed; the average particle size was 9 μm, and the carbon yield after pyrolysis was 50 wt %. The phenolic resin was sieved through a 200-mesh screen to remove agglomerates prior to use in preparing the light emitting material. About 90 grams of Fortafil 3© milled PAN-based carbon fiber (approximately 140 μm in length) were mechanically slurried in 3 liters water for 15 min. About 60 grams of the phenolic resin was added to the water-fiber slurry to form a dilute fiber-resin-water slurry containing less than about 5 wt % solids. The solids contained about 60 wt % carbon fibers and about 40 wt % phenolic resin. The dilute fiber-resin-water slurry was blended for 20 minutes to obtain a homogeneous distribution. A piece of graphitic foam made in accordance with U.S. Pat. No. 6,033,506 was machined into a ¼″ thick by 4.5″ diameter block and placed as the filter medium in a molding apparatus. The slurry was then vacuum molded over the foam such that the water slurry was forced to flow through the foam, leaving the fibers/phenolic “filter cake” deposited on the surface of the foam. A forced-draft air dryer was used to dry the molded green articles at 50° C. for 16 hours. The curing process was then accomplished by stepwise heating: 3 hours at 80° C., 3 hours at 100° C., and 12 hours at 130° C. in the forced-draft air dryer. The cured material was carbonized to form the final composite article by heating, in an argon atmosphere, at a rate of about 100° C./hour to about 1000° C. and holding at that temperature for about 1 hour. The densities of the carbonized composite articles ranged from about 0.4 to about 0.45 g/cm³. The thickness of the CBCF section of the composite was roughly ⅛″. Surprisingly, upon sectioning through the thickness of the composite structure, it was found that the CBCF had penetrated several cells deep into the open cells of the foam.

The resulting structure is illustrated schematically at 10 in FIG. 1. A body of open-cell carbon foam 14 has a working surface 11 and at least one other secondary surface 12. The CBCF layer 13 has been deposited on the working surface 11 and has infiltrated the foam to some depth, forming a graded transitional layer 15, which helps the layer 15 to adhere, improves heat transfer, and also provides some extra margin for subsequent machining operations if desired. The carbon foam 14 provides a continuous high-conductivity thermal path from the working surface 11 to the opposite secondary surface 12.

### EXAMPLE 4

A sample of Durez 22352 phenolic resin was prepared as described in the previous example. About 90 grams of Fortafil 3© milled PAN-based carbon fiber (approximately 140 microns in length) were mechanically mixed with 600 ml of ethanol for 15 min. About 60 grams of the phenolic resin was added to the ethanol-fiber slurry to form a dilute fiber-resin-ethanol emulsion of fibers in a resin-ethanol solution containing less than about 20 wt % solids. The solids contained about 60 wt% carbon fibers and about 40 wt% phenolic resin. The fiber-resin-ethanol emulsion was blended for 20 min to obtain a homogeneous distribution. A piece of graphitic foam made in accordance with U.S. Pat. 6,033,506 was machined into a ¼″ thick by 4″ by 8″ rectangular block. The slurry was then poured over the foam, allowing the ethanol/phenolic solution to slowly seep into the foam, without any applied suction, leaving the fibers as wet “filter cake” on the surface of the foam. The phenolic/ethanol solution remaining with the fibers contained sufficient resin so that after the ethanol evaporated during drying, the fibers were bound by the remaining resin at the contact points between the fibers. A forced-draft air dryer was used to dry the molded green articles at 50° C. for 16 h. The curing process was then accomplished by stepwise heating: 3 h at 80° C., 3 h at 100° C., and 12 h at 130° C. in the forced-draft air dryer. The cured layups were carbonized to form the final composite articles by heating, in an argon atmosphere, at a rate of about 100° C./h to about 1000° C. and holding at that temperature for about 1 h. The carbonized article was cut in half and one of the halves was graphitized at 2800° C. for 2 hours under Argon. The densities of the carbonized and graphitized composite articles ranged from about 0.4 to about 0.45 g/cm³. The thickness of the CBCF section of the composite was roughly ⅛″. See FIG. 6.

### EXAMPLE 5

A sample of Durez 22352 phenolic resin was prepared as outlined in example 1. About 90 g of Amoco DKD-x milled carbon fiber (approximately 100 microns in length) were mechanically mixed with 600 ml of ethanol for 15 min. About 60 g of the phenolic resin was added to the ethanol-fiber slurry to form a dilute fiber-resin-ethanol emulsion of fibers in a resin-ethanol solution containing less than about 20 wt % solids. The solids contained about 60 wt % carbon fibers and about 40 wt % phenolic resin. The fiber-resin-ethanol emulsion was blended for 20 min to obtain a homogeneous distribution. A piece of graphitic foam made in accordance with U.S. Pat. No. 6,033,506 was machined into a ¼″ thick by 4″ by 8″ rectangular block. The slurry was then poured over the foam as before so the ethanol/phenolic solution could slowly seep into the foam, leaving the fibers as wet “filter cake” on the surface of the foam. The phenolic/ethanol solution remaining with the fibers contained sufficient resin so that after the ethanol evaporated, the fibers were bound by the remaining resin at the contact points between the fibers. A forced-draft air dryer was used to dry the molded green articles at 50° C. for 16 h. The curing process was then accomplished by stepwise heating: 3 h at 80° C., 3 h at 100° C., and 12 h at 130° C. in the forced-draft air dryer. The cured layups were carbonized to form the final composite articles by heating, in argon, at a rate of about 100° C./h to about 1000° C. and holding at that temperature for about 1 h. The carbonized article was cut in half and one of the halves was graphitized at 2800° C. for 2 hours under Argon. The densities of the carbonized and graphitized composite articles ranged from about 0.4 to about 0.45 g/cm³. The thickness of the CBCF section of the composite was roughly ⅛″. See FIGS. 7 & 8.

Skilled artisans will appreciate that the inventive composites as disclosed herein allow the designer to exploit the favorable properties of both carbon foam and CBCF. The inventive articles can be prepared by molding an oversized billet of the material and machining it to final size and shape. Machining includes cutting, grinding, sawing, sanding, embossing, etc. Therefore, highly complex-shaped articles can be manufactured. It was previously observed with monolithic CBCF that removal of surface material by machining—even smoothing with sandpaper—does not deleteriously affect the light emitting or scattering ability of the surface. Articles prepared in accordance with the present invention will preserve this property to a large degree because the CBCF has actually infiltrated the foam to some depth. Within this “mixed phase” layer, the intimate interweaving of the two materials ensures good thermal contact between the two phases. Also, the inventive composite articles can be prepared by machining the graphite foam to a very detailed complex shape and then infiltrating the selected surface with CBCF as a relatively uniform layer, thus producing a net shaped composite with good thermal dissipation capability.

The inventive materials can be made even more useful by infiltrating some or all of the underlying carbon foam with metal as described generally in U.S. Pat. Nos. 6,033,506 and 6,037,032. One possible embodiment of this approach is illustrated schematically at 20 in FIG. 2., in which like structures are given like numbers as in FIG. 1. Here the secondary surface 12′ is infiltrated with metal 26 to some depth 27, for added strength, machinability, or ease in brazing. The resulting material can then be brazed to a metal or ceramic substrate. Many well known brazing methods are quite suitable for this purpose. FIG. 3 illustrates one possible configuration of this variant that is particularly suitable for placing in the collector of a traveling wave tube as discussed in U.S. Pat. No. 5,786,666. For instance, with copper 26′ infiltrated into the composite material 14″, it can then be brazed to a copper substrate using a typical Au—Cu brazing alloy at about 1035° C. in a hydrogen atmosphere.

It will be understood that the inventive articles can also be formed by other techniques similar in principle to the methods described in the foregoing examples. For example, using the afore described fiber/resin/ethanol system, the slurry can be sprayed or painted onto the carbon foam (rather than poured), allowing very complex shapes to be coated with the CBCF material. It will also be understood that the depth of infiltration can be controlled over a wide range by modifying process variables such as fiber and resin loading, fiber length, foam pore size, etc. Thus, skilled artisans can achieve the optimal combination of properties for a given application without undue experimentation.

While there has been shown and described what are at present considered the preferred embodiments of the invention, it will be obvious to those skilled in the art that various changes and modifications can be made therein without departing from the scope of the inventions defined by the appended claims.

What is claimed is:

1) An article for passively converting energy from one form to another comprising;
a graded composite of carbon-bonded carbon fiber material,
carbon foam,
at least one working surface, and
at least one secondary surface,
wherein said graded composite of carbon-bonded carbon fiber material performs energy conversion at said working surface and said carbon foam provides a thermally conductive path between said working surface and said secondary surface of said article.

2) An article in accordance with claim 1 wherein said energy conversion comprises at least one of the following:
a) the conversion of RF energy to sensible heat;
b) the conversion of absorbed radiant energy to sensible heat;
c) the conversion of sensible heat to radiant energy; and,
d) the conversion of electron kinetic energy to sensible heat.

3) An article in accordance with claim 1 wherein said carbon-bonded carbon fiber material comprises carbon fibers having individual lengths generally not more than about 1 mm and individual diameters generally not more than about 25 μm.

4) An article in accordance with claim 1 wherein said carbon foam comprises a pitch-derived graphitic foam having interconnected pores and an average pore diameter less than about 1 mm.

5) An article in accordance with claim 1 wherein said carbon-bonded carbon-fiber material substantially fills the pores of said carbon foam on said working surface to a depth of at least one pore diameter.

6) An article in accordance with claim 1 wherein the thickness of said carbon-bonded carbon-fiber material varies in at least one direction along said working surface.

7) An article in accordance with claim 6 wherein said article comprises a microwave load and said thickness variation forms a tapered impedance element.

8) An article in accordance with claim 1 wherein said carbon foam is at least partially infiltrated on said secondary surface with a metal selected from the group consisting of Cu, Al, Ni, and their alloys.

9) A process for preparing a passive energy-converting composite article comprising the steps of:
a) blending carbon fibers with a carbonizable organic powder to form a mixture;
b) dispersing said mixture into an aqueous slurry;
c) vacuum molding said aqueous slurry onto at least one working surface of a carbon foam body to form a green article;
d) drying and curing said green article to form a cured article; and,
e) carbonizing said cured article at a temperature of at least about 1000° C. to form an adherent carbon-bonded carbon fiber material grading into said carbon foam on said working surface, said composite article having a bulk density less than 1 g/cm³.

10) A process in accordance with claim 9 wherein carbon-bonded carbon fiber material comprises carbon fibers derived from a fibrous material selected from the group consisting of rayon, polyacrylonitrile, pitch, and mesophase pitch.

11) A process in accordance with claim 9 wherein said carbon foam is a graphitic foam.

12) A process in accordance with claim 9 further comprising the additional step:
f) graphitizing the carbonized article at a temperature of at least 2400° C.

13) A process for preparing a passive energy-converting composite article comprising the steps of:
a) blending carbon fibers with a carbonizable organic powder to form a mixture;
b) dispersing said mixture into an alcohol solution;
c) molding said alcohol slurry onto at least one working surface of a carbon foam body to form a green article;
d) drying and curing said green article to form a cured article; and,
e) carbonizing said cured article at a temperature of at least about 1000° C. to form an adherent carbon-bonded carbon fiber material grading into said carbon foam on said working surface, said composite article having a bulk density less than 1 g/cm³.

14) A process for preparing a composite article in accordance with claim 13 wherein said carbon-bonded carbon fiber material comprises carbon fibers derived from a fibrous material selected from the group consisting of rayon, polyacrylonitrile, pitch, and mesophase pitch.

15) A process for preparing a composite article in accordance with claim 13 wherein said carbon foam is a graphitic foam.

16) A process for preparing a composite article in accordance with claim 13 further comprising the additional step of: f) graphitizing the carbonized article at a temperature at least 2400° C.

17) A process for preparing a composite article in accordance with claim 14 wherein said carbon fibers have individual diameters generally not more than about 25 μm and individual lengths generally not more than about 1 mm.

18) A process in accordance with claim 13 wherein said carbonizable organic material is selected from the group consisting of pitch and thermosetting resin.

19) A process in accordance with claim 18 wherein said thermosetting resin comprises a phenolic resin.

20) A process in accordance with claim 19 wherein said phenolic resin comprises a mixture of novolac and hexamethylenetetramine.

21) A process for preparing a composite article in accordance with claim 13 further comprising the additional step of machining said composite article to final dimensions.

22) A process for preparing a composite article in accordance with claim 13 further comprising the additional step of:
g) infiltrating a portion of said carbon foam with a metal on at least one selected secondary surface of said foam.
